(19) United States
(12) Patent Application Publication
(10) Pub. No.: US 2024/0194981 A1
(43) Pub. Date: Jun. 13, 2024

(54) BATTERY CELL COMPRISING STRENGHTENING AREA AND BATTERY DEVICE COMPRISING THE SAME

(71) Applicant: SK ON CO., LTD., Seoul (KR)

(72) Inventors: John Cronin, Jericho, VT (US); Yea Eun KIM, Daejeon (KR); Soo Min PARK, Daejeon (KR); Hyung Ju PAIK, Daejeon (KR); Hae Ryong JEON, Daejeon (KR)

(21) Appl. No.: 18/352,253

(22) Filed: Jul. 14, 2023

Related U.S. Application Data
(60) Provisional application No. 63/430,913, filed on Dec. 7, 2022.

(51) Int. Cl. H01M 50/103; H01M 10/647; H01M 10/653; H01M 10/6555; H01M 10/6562; H01M 50/14; H01M 50/209

(52) U.S. Cl. CPC H01M 50/103; H01M 10/647; H01M 10/653; H01M 10/6555; H01M 10/6562; H01M 50/14; H01M 50/209

(57) ABSTRACT

A battery cell including an electrode assembly and a case accommodating the electrode assembly is provided. The case includes a support region surrounding at least a portion of the electrode assembly and a reinforcing region disposed on the support region.

### CROSS-REFERENCE TO RELATED APPLICATION(S)

This patent document claims the benefit of U.S. Provisional Patent Application No. 63/430,913 filed on Dec. 7, 2022, the disclosure of which is incorporated herein by reference in its entirety.

### BACKGROUND

The present disclosure relates to a battery cell including a reinforcing region and a battery device including the same. More specifically, the present document relates to a battery cell including a reinforcing region and a battery device, having improved strength and stability of the battery cell.

A battery cell includes an electrode assembly and a case accommodating the electrode assembly.When external impacts (e.g., from a vehicle collision) is transmitted to the battery cell, a short circuit may occur in the battery cell, and additional events may occur due to the short circuit. In order to prevent a short circuit of a battery cell due to an external impact, a structure of the battery cell for enhancing durability of the battery cell has been studied.

### SUMMARY

A battery cell may include an electrode assembly and a case accommodating the electrode assembly. The case is made of a can, to protect the electrode assembly from external impacts.Strength and weight of the caseare trade-offs. As the case is formed to be thinner to reduce the weight of the battery cell, the strength of the case may be reduced. An aspect of the present disclosure is to provide a battery cell including a reinforcing region and a battery device, capable of efficiently improving the strength of a can.

According to an aspect of the present disclosure, a battery cell includes an electrode assembly and a case accommodating the electrode assembly. The case includes a support region surrounding at least a portion of the electrode assembly and a reinforcing region disposed on the support region.

According to an embodiment, the support region may include a plurality of ironing regions formed using an ironing process.

According to an embodiment, the reinforcing region may include at least one support rod disposed on the support region.

According to an embodiment, the reinforcing region may be disposed on the support region, and include a reinforcing cover having a plurality of protrusions and a plurality of grooves.

According to an embodiment, the case may include a wide surface, a narrow surface, and a corner portion positioned between the wide surface and the narrow surface. The reinforcing region may be disposed on at least one of the wide surface, the narrow surface, and the corner portion. The reinforcing region may be disposed on at least one of the wide surface, the narrow surface, and the corner portion.

According to an embodiment of the present document, a battery case includes a cell assembly including a plurality of battery cells, and a housing accommodating the cell assembly. Each of the plurality of battery cells may include an electrode assembly and a case accommodating the electrode assembly. The case may include a support region surrounding at least a portion of the electrode assembly and a reinforcing region disposed on the support region. The cell assembly may include a heat dissipation space located between a support region of each of the plurality of battery cells.

According to an embodiment of the present document, the support region may include an ironing region formed using an ironing process. A first thickness of the ironing region may be less than a second thickness of the reinforcing region.

According to an embodiment of the present document, the reinforcing region may include at least one support rod connected to the support region.

According to an embodiment of the present document, the reinforcing region may be connected to the support region, and may include a reinforcing cover having a plurality of protrusions and a plurality of grooves.

According to an embodiment of the present document, the battery device may further include a heat dissipation member attached to the support region and located within the heat dissipation space.

According to an embodiment of the present document, the battery device may further include a thermal adhesive connecting the cell assembly and the housing.

According to an embodiment of the present document, the reinforcing region may include a first protrusion extending from an outer surface of the support region in a first direction, and a second protrusion extending in the first direction.

According to an embodiment, the reinforcing region may include a third protrusion extending from a first end of a first outer surface of the support region in a first direction, and a fourth protrusion extending from a second end of a second outer surface of the support region in a second direction,opposite to the first direction. The third protrusion may be located at a first end of the case, and the fourth protrusion may be located at a second end of the case, opposite to the first end.

According to an embodiment, the reinforcing region may includea plurality of fifth protrusions extending from a first outer surface of the support region in a first direction and a plurality of sixth protrusions extending from a second outer surface of the support regionina second direction, opposite to the first direction.

According to an embodiment, the reinforcing region may include a seventh protrusion including an insertion portion and an eighth protrusion in which a groove for accommodating the insertion portion is formed.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is an exploded perspective view of a battery cell according to an embodiment;

FIGS. 2A, 2B, and 2C are views for illustrating an upper cap assembly according to an embodiment;

FIGS. 3A to 3F are a view for illustrating an assembly process of an upper cap assembly and an electrode assembly according to an embodiment;

FIGS. 4A to 4F are a view for illustrating an assembly process of an electrode assembly, a jelly roll bag, and a can according to an embodiment;

FIGS. 5A and 5B are diagrams for illustrating a crush test of a prismatic cell battery;

FIG. 6 is a diagram for illustrating a manufacturing process of a battery cell according to an embodiment;

FIGS. 7A and 7B are views for illustrating an impact extrusion process according to an embodiment;

FIGS. 8A and 8B are a diagram for illustrating an ironing process according to an embodiment;

FIGS. 9A to 9E are views for illustrating a can to which an ironing process is applied, according to various embodiments;

FIGS. 10A to 10F are views for illustrating a can including a support rod according to various embodiments;

FIGS. 11A to 11E are views for illustrating a can including a reinforcing cover according to various embodiments;

FIG. 12A is a top view of a battery device, according to an embodiment. FIG. 12B is a cross-sectional view along line C-C′ of FIG. 12A;

FIG. 13 is a top view of a battery device according to an embodiment;

FIG. 14 is a top view of a battery cell, according to an embodiment; and

FIG. 15A is a top view of a battery cell, according to an embodiment. FIG. 15B is a perspective view of a cell assembly, according to an embodiment.

### DETAILED DESCRIPTION

Embodiments of the present disclosure will be more fully described below with reference to the accompanying drawings, in which like symbols indicate like elements throughout the drawings, and embodiments are shown. However, embodiments of the claims may be implemented in many different forms and are not limited to the embodiments described herein. The examples given herein are non-limiting and only examples among other possible examples.

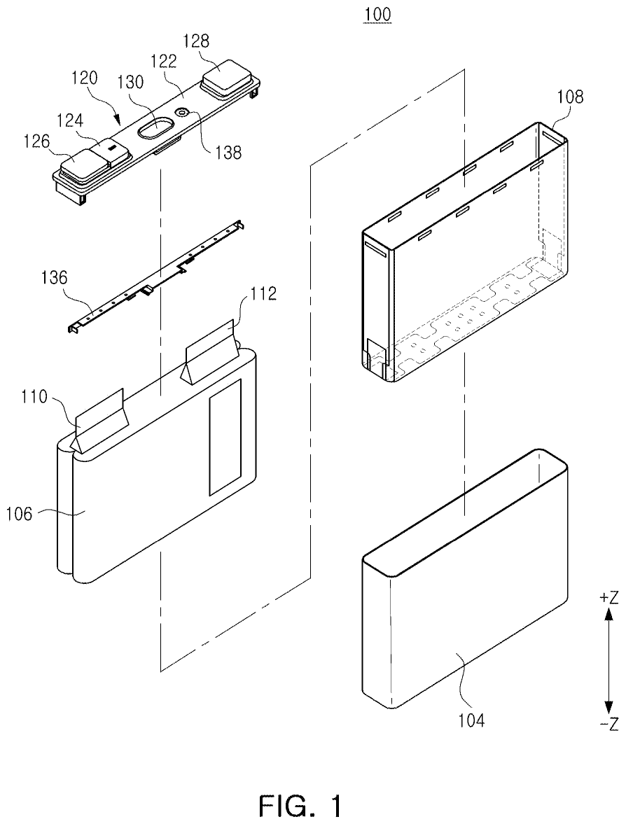

FIG. 1 is an exploded perspective view of a battery cell according to an embodiment.

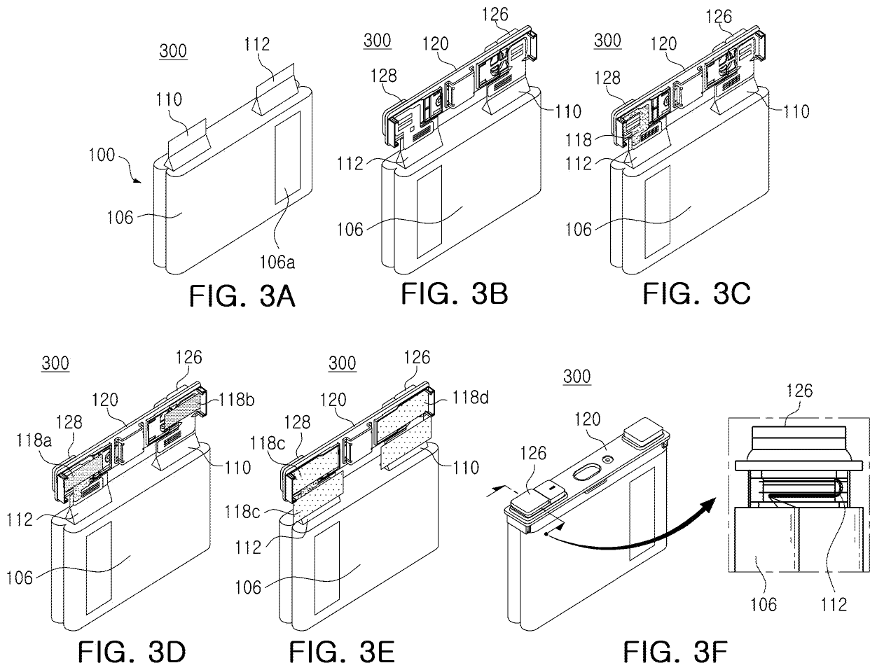

Referring to FIG. 1, a battery cell 100 may be a prismatic cell. Prismatic cells are widely used in powertrains of electric vehicles. The prismatic cells may be stacked together in a rectangular shape, allowing more efficient use of space. Prismatic cells are generally rectangular and have a higher power density than cylindrical cells. Prismatic cells also provide better performance in cold weather and less damage from vibration. However, prismatic cells may be more expensive to manufacture than cylindrical cells. In addition, prismatic cells are less likely to fail due to vibration or movement. Prismatic cells may deliver more power than cylindrical battery cells due to spatial optimization of the rectangular shape thereof. The prismatic battery cell 100 includes a rectangular can 104 that may be formed of steel, aluminum, aluminum alloy, plastic, or other metals having sufficient structural strength. The can 104 may be manufactured according to various different methods including deep draw or impact extrusion. The method for manufacturing the can 104 may be combined with wall ironing to achieve the final geometry, thickness and tolerances. The can 104 may be wrapped with cell cover tape. A jelly roll 106 includes a stacked anode, cathode and separator. A jelly roll 106 type electrode assembly configured to have a structure of a long sheet type cathode and a long sheet type anode to which an active material is applied is wound. At the same time, the stacked-type electrode assembly has a structure in which a separator is disposed between a cathode and an anode or has a structure in which a plurality of cathodes and anodes having a predetermined size are sequentially stacked and a separator is disposed between each of the cathodes and the anode. The jelly roll-type electrode assembly is easy to manufacture and has high unit mass and energy density, compared to a sheet-type electrode assembly. In some batteries, one or more jelly rolls 106 are inserted into can 104. Each jelly roll 106 electrode assembly is included inside a polymer jelly roll bag 108 sealed inside the can 104. Each jelly roll 106 includes a cathode foil 112 formed of aluminum. The aluminum foil is coated with the electrode slurry. A first operation of electrode manufacturing is a slurry mixing process in which an active raw material is combined with a binder, a solvent and an additive. This mixing process should be performed separately for anode and cathode slurries. Viscosity, density, solids content and other measurable properties of the slurry affect battery quality and electrode uniformity. For example, a slurry having a faster drying rate, a higher solids content, a lower rate capability, and a low viscosity is generated as a solvent content is higher. Thereafter, the cathode slurry is applied to an aluminum foil and dried. A slot die coater is a method of coating a foil in which a slurry is spread through slot gaps on the moving foil receiving tension over rollers. In some embodiments, this may be performed simultaneously on both sides of the foil. This production method enables high speed, while achieving precision in coating thickness. A drying process may be incorporated into a continuous coating. The drying process should achieve three objectives: diffusion of the binder, sedimentation of particles, and evaporation of the solvent. Air floatation is a method of drying the slurry on the foil. Uniformity of the electrode coating and drying process affects the safety, consistency and life cycle of the prismatic battery cell 100. The electrode should go through a calendaring process in which electrode porosity and twist are controlled by compressing the coated electrode sheet to a uniform thickness and density. Each jelly roll 106 includes an anode foil 110 formed of copper foil. The anode foil 110 is provided similarly to a cathode foil 112. Each jelly roll 106 may include a cathode connector (not shown) that makes an electrical connection between the inner end portion of the cathode foil 112 and the cathode terminal 128. Each jelly roll 106 may include an anode connector (not shown) that makes an electrical connection between the inner end portion of the anode foil 110 and an anode terminal 126. Each jelly roll 106 may include a cathode connector mask (e.g., a cathode connector mask 118 in FIG. 3C).

Each prismatic battery cell 100 may have an upper cap assembly 120 welded or otherwise bonded to the top of the can 104. The upper cap assembly 120 may include a base plate 122 attached to the can 104. The base plate 122 isolates the inside and outside of the cell by welding with the can 104. The base plate 122 may serve as a rigid support structure for elements within the upper cap assembly 120. The upper cap assembly 120 may include a plurality of upper insulators 124 to insulate the base plate 122. The upper insulator 124 may prevent leakage of an electrolyte from the prismatic battery cell 100. Additionally, the upper insulator 124 may isolate the can 104 from the cathode foil 112 and prevent penetration of moisture and gases from the outside of the cell. A portion of the upper insulator 124 may protect a current interrupting device. The upper cap assembly 120 includes a cathode terminal 128 electrically connecting the inside and outside of the prismatic battery cell 100. The upper cap assembly 120 includes an anode terminal 126 electrically connecting the inside and outside of the prismatic battery cell 100.

The upper cap assembly 120 may include a vent 130 allowing exhaust gases from the prismatic battery cell 100 to be discharged in a controlled direction and at a controlled pressure. The upper cap assembly 120 may include a vent guard 132 protecting the vent 130 from the inside of the prismatic battery cell 100 in order to prevent the vent 130 from malfunctioning. The upper cap assembly 120 may include an overcharge safety device 134 preventing an external current from being introduced using an internal gas pressure of the prismatic battery cell 100. The upper insulator 124 may be multi-component. In some embodiments, side portions of the upper insulator 124 may be mounted on the edges of the can 104 and the upper cap assembly 120. An electrolyte cap 138 may seal an electrolyte solution inside the prismatic battery cell 100.

The battery cell 100 may include an insulator 136 located between the upper cap assembly 120 and the can 104.

In this document, the electrode assembly of the battery cell 100 is described as the jelly roll 106, but the electrode assembly of the battery cell 100 is not limited to the jelly roll 106. For example, the jelly roll 106 may be replaced with a stack type electrode assembly or a Z-folding type electrode assembly. According to an embodiment, the jelly roll 106 described herein may refer to an electrode assembly.

In this document, the can 104 may be referred to as a case or housing.

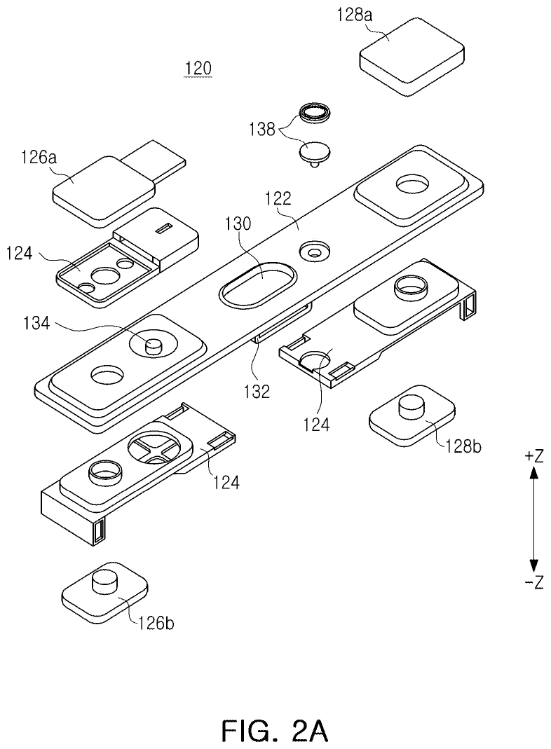

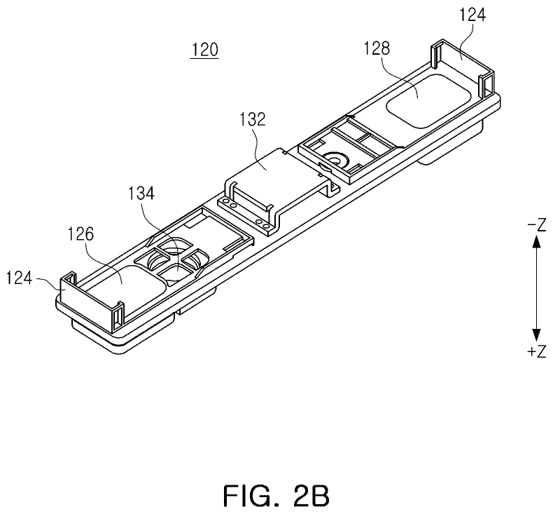

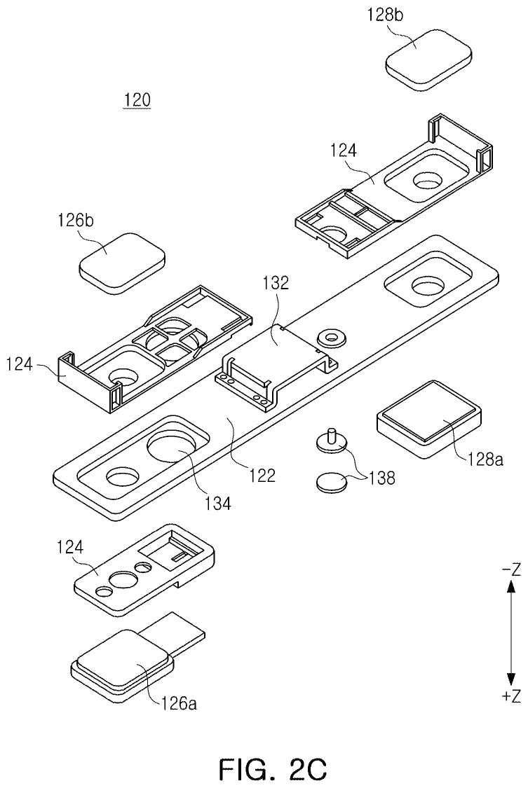

FIGS. 2A, 2B and 2C show a configuration and component functions of the upper cap assembly 120. For example, FIG. 2A is an exploded perspective view of the upper cap assembly 120 according to an embodiment of the present disclosure. FIG. 2B is a rear perspective view of the upper cap assembly 120 according to an embodiment of the present disclosure. Description of the upper cap assembly 120 of FIG. 1 may be applied to the upper cap assembly 120 of FIGS. 2A, 2B and 2C.

The upper cap assembly 120 serving as a cover for the prismatic battery cell 100 is a complex assembly including a plurality of welded components. Adhesives may be used instead of welding specific components.

The prismatic battery cell 100 may include the vent 130. The vent 130 provides overpressure alleviation when temperature and corresponding pressure increase in the prismatic battery cell 100. For example, the vent 130 may be activated in a pressure range of 10 to 15 bar. The vent 130 may be laser-welded to the upper cap assembly 120.

The prismatic battery cell 100 may include the can 104. The can 104 may generally be formed of deep-drawn aluminum or stainless steel to prevent moisture from entering the cell, while providing diffusion resistance to organic solvents, such as liquid electrolytes. The most important reason the can 104 is typically formed of deep-drawn aluminum alloy or stainless steel is to reduce a welding point to improve the mechanical strength of the can 104. The prismatic battery cell 100 may be filled with an electrolyte. After electrolyte filling, the electrolyte cap 138 may be welded to the upper cap assembly 120 or a locking ball (not shown) may be forced into an opening of the electrolyte cap 138. The cell may have an overcharge safety device 134 that may disconnect current flow when high internal pressure is reached in the prismatic battery cell 100. A rise in pressure is usually a result of high temperatures.

According to an embodiment, the cathode terminal 128 may be provided in plural. For example, the cathode terminal 128 may include a first cathode terminal 128a in which at least a portion is exposed to the outside of the battery cell 100 and a second cathode terminal 128b connected to a cathode foil (e.g., the cathode foil 112 of FIG. 1). The second cathode terminal 128b may be electrically connected to the first cathode terminal 128a. For example, a portion of the second cathode terminal 128b may contact the first cathode terminal 128a.

According to an embodiment, the anode terminal 126 may be provided in plural. For example, the anode terminal 126 may include a first anode terminal 126a in which at least a portion is exposed to the outside of the battery cell 100 and a second anode terminal 126b connected to an anode foil (e.g., the anode foil 110 of FIG. 1). The second anode terminal 126b may be electrically connected to the first anode terminal 126a. For example, a portion of the second anode terminal 126b may contact the first anode terminal 126.

FIGS. 3A to 3F are a view illustrating an assembly process of an upper cap assembly and an electrode assembly according to an embodiment. A battery cell manufacturing process 300 may include an assembly process of the upper cap assembly 120 and the jelly roll 106.

Referring to FIG. 3A, a sealing tape 106a may be attached to the jelly roll 106. According to an embodiment, the sealing tape 106a can cover at least a portion of the jelly roll 106. According to an embodiment, the sealing tape 106a may seal a portion of the jelly roll 106.

Referring to FIG. 3B, the jelly roll 106 may be connected to the upper cap assembly 120. For example, a connection component for connecting the jelly roll 106 and the upper cap assembly 120 may be prepared. The upper cap assembly 120 may be closely attached to the jelly roll 106 using the connection component. For example, the cathode terminal 128 of the upper cap assembly 120 may be connected to the cathode foil 112 of the jelly roll 106, and the anode terminal 126 of the upper cap assembly 120 may be connected to the jelly roll 106. The cathode terminal 128 may be welded to the cathode foil 112 and the anode terminal 126 may be welded (e.g., ultrasonic-welded) to the anode foil 110.

Referring to FIG. 3C, at least a portion of the cathode terminal 128 may be masked. For example, the cathode connector mask 118 may be disposed to cover a portion of the cathode terminal 128. The cathode connector mask 118 may protect the cathode terminal 128. Although not shown, the description of the masking of the cathode terminal 128 may be applied to the anode terminal 126 as well.

Referring to FIG. 3D and/or FIG. 3E, tape may be attached to at least a portion of the cathode terminal 128 and the anode terminal 126. For example, the battery cell 100 may include welding tapes 118a, 118b, 118c, and 118d attached to at least a portion of the cathode terminal 128, the anode terminal 126, the cathode foil 112, and/or the anode foil 110. According to an embodiment, the welding tapes 118a, 118b, 118c, 118d may be attached to at least a portion of a joint portion of the cathode terminal 128, the anode terminal 126, the cathode foil 112, and/or the anode foil 110. As the joint portion is covered with the welding tapes 118a, 118b, 118c, and 118d, the cathode terminal 128 and the anode terminal 126 may be protected.

Referring to FIG. 3F, the anode foil 110 connected to the anode terminal 126 may be folded. For example, when the upper cap assembly 120 is disposed on the jelly roll 106, at least a portion of the anode foil 110 may be folded. Although not shown, when the upper cap assembly 120 is placed on the jelly roll 106, the cathode foil 112 may also be folded.

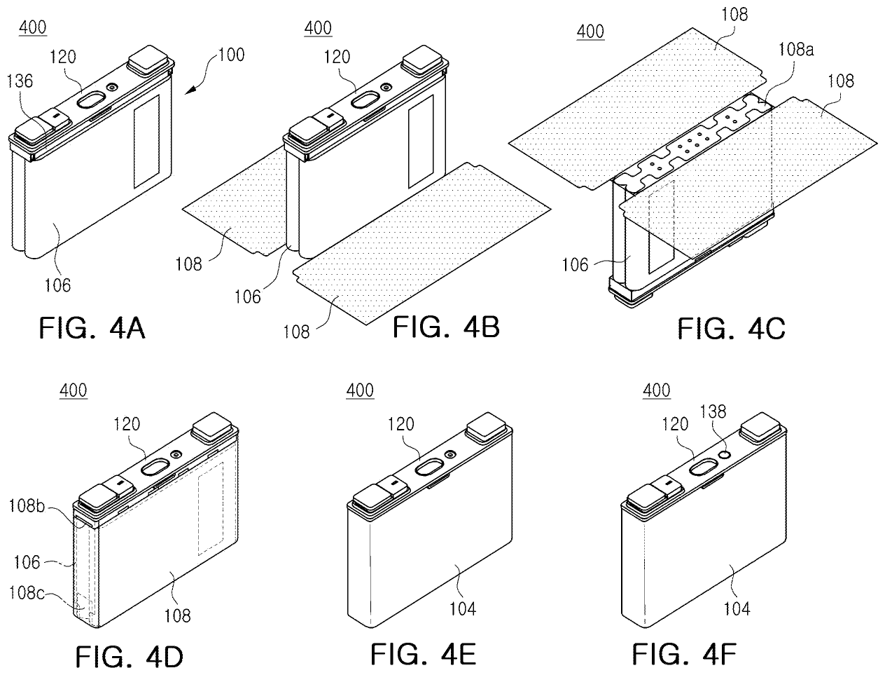

FIGS. 4A to 4F are a view illustrating an assembly process of an electrode assembly, a jelly roll bag, and a can. A battery cell manufacturing process 400 may include an assembly process of the jelly roll 106, the jelly roll bag 108, and the can 104.

Referring to FIG. 4A, an insulator 136 may be installed on the battery cell 100. For example, the insulator 136 may be disposed between the can 104 and the cap assembly 120.

Referring to FIG. 4B, the jelly roll bag 108 may be prepared. The jelly roll bag 108 may cover at least a portion (e.g., a side surface) of the jelly roll 106. The jelly roll 106 may be surrounded by the jelly roll bag 108. The jelly roll bag 108 may protect the jelly roll 106 from external impact. In FIG. 4B, a structure in which the jelly roll bag 108 is disposed on two side surfaces of the jelly roll 106 is shown, but the structure of the jelly roll bag 108 is not limited thereto. For example, according to an embodiment, the jelly roll bag 108 may be formed to cover four side surfaces of the jelly roll 106.

Referring to FIG. 4C, an insulator 108a may be attached to the jelly roll 106. According to an embodiment, in a state in which the jelly roll bag 108 is unfolded, the insulator 108a may be attached to a lower portion of the jelly roll 106. The insulator 108a may be referred to as a lower insulator.

Referring to FIG. 4D, at least some of the components of the battery cell 100 may be taped. For example, the battery cell 100 may include the upper cap assembly 120, the can 104, and/or at least one first tape 108b attached onto insulator 136, and/or a second tape 108c attached to a lower portion of the jelly roll bag 108 along a side portion of the insulator 136.

Referring to FIG. 4E, the jelly roll 106 may be inserted into the can 104. The jelly roll 106 and/or the jelly roll bag 108 may be inserted into the can 104.

According to an embodiment, the battery cell manufacturing process 400 may include a wetting process of the jelly roll 106. For example, the jelly roll 106 may be initially wetted by an electrolyte delivered through an electrolyte injection port. For example, partial vacuum may be formed in the prismatic battery cell 100, and a predetermined amount of electrolyte may be injected through the electrolyte injection port. The partial vacuum may improve the distribution and wetting of all layers within the jelly roll 106. Wetting of all layers within the jelly roll 106 may require a rolling or spinning protocol to enhance wetting.

According to an embodiment, the battery cell manufacturing process 400 may include a quality check process for the initial wetting process, such as checking a weight of the prismatic battery cell 100 immediately after charging. For example, a second electrolyte charging operation in which an electrolyte is charged to achieve a desired weight may be applied to the battery cell. According to an embodiment, the battery cell manufacturing process 400 may include a pre-formation process of charging the prismatic battery cell 100 and discharging gas.

Referring to FIG. 4F, the electrolyte injection port may be sealed. For example, the electrolyte cap 138 may be inserted into the electrolyte injection port.

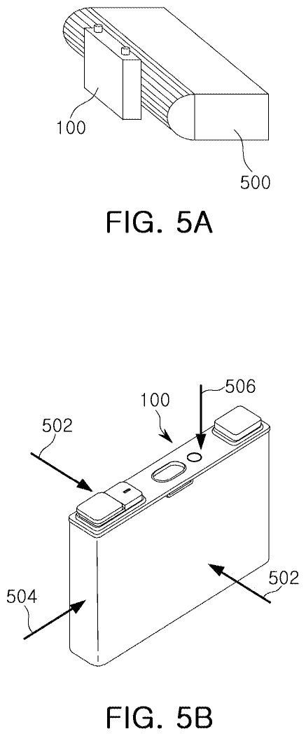

FIGS. 5A and 5B are diagrams for illustrating a crush test of a prismatic cell battery.

For example, FIG. 5A illustrates a battery cell 100 and a vertical crush test tool 500. The vertical crush test tool 500 illustrated in FIG. 5A may be selectively applied, as an example. FIG. 5A illustrates a positional relationship between a prismatic cell battery 100 and a vertical crush test tool 500 during a vertical crush test.

FIG. 5B illustrates a first crush test direction (e.g., vertical crush test direction) 502, a second crush test direction 504 (e.g., narrow vertical crush test direction), and a third crush test direction 506 (e.g., horizontal crush test direction), in which battery cells 100 may be evaluated for their crush strength in relation to various standards).

In an embodiment, the battery cell 100 may receive pressure or force in a first crush test direction 502, a second vertical crush test direction 504, and/or a third crush test direction 506 using the vertical crush test tool 500, and crush strength thereof may be evaluated. For example, “UL Standard For Safety Batteries for Use In Electric Vehicles, UL 2580, 3rd Edition, Apr. 1, 2020” discloses requirements for crush strength as follows. “These standards evaluate the ability of electrical energy storage assemblies to safely withstand simulated abuse conditions and prevent exposure of persons to harm as a result of abuse.” UN ECE R100 Rev2 is an important European requirement of the United Nations (UN). This regulation specifies all tests that should be performed on lithium batteries installed in four-wheeled electric vehicles to transport people or goods in category M and N road vehicles with electric traction. Two of the standards include a mechanical integrity test that verify resistance of a Rechargeable Energy Storage System (REESS) under contact loads that may occur in a vehicle crash. A mechanical impact test of 100 KN crush using a 75 mm radius crush platen and 80 ms up to 28 G depending on a vehicle class in a positive or negative direction or both directions. The mechanical impact test is generally performed on a sled test machine.

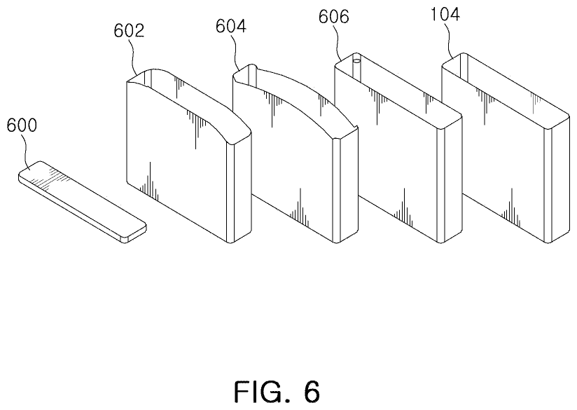

FIG. 6 is a view for illustrating an impact extrusion process for forming a case of a prismatic cell battery according to an embodiment. For example, FIG. 6 illustrates five stages of an impact extrusion manufacturing process for converting an aluminum slug 600 into a can 104 for a prismatic cell battery 100.

A first phase is an aluminum slug 600. The aluminum slug 600 may be extruded and transformed into a first workpiece 602.

The first workpiece 602 may be drawn into a second workpiece 604 through ironing. At least a portion of a second workpiece 604 may be cut and transformed into a third workpiece 606. The third workpiece 606 may be trimmed and polished to a final state of the can 104. For example, an unintended protrusion formed on a surface of the third workpiece 606 may be removed. The first workpiece 602, the second workpiece 604, and the third workpiece 606 may be formed during processing of the aluminum slug 600 into the can 104. In an embodiment, the first workpiece 602, second workpiece 604, and third workpiece 606 may be referred to as a first level, a second level, and a third level, respectively.

In FIG. 6, the can 104 made of aluminum is described, but a material of the can 104 is not limited thereto. For example, the can 104 may include the other metal (e.g., titanium).

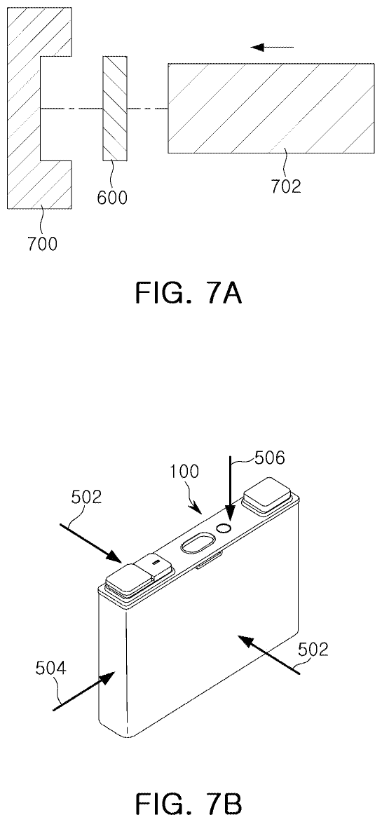

FIGS. 7A and 7B are views for illustrating an impact extrusion process according to an embodiment. For example, FIGS. 7A and 7B illustrate two cross-sections of an impact extrusion process. An aluminum slug 600 may be disposed between a mandrel 700 and a driving slug 702. The driving slug 702 may be moved in a direction of an arrow until reaching a position illustrated in FIG. 7B, typically using a pneumatic or hydraulic press. When the driving slug 702 reaches the position illustrated in FIG. 7B, the aluminum slug 600 may be formed as a workpiece (e.g., the first workpiece 602 of FIG. 6) for producing a can 104 for a prismatic cell battery 100. A size and shape of mandrel 700 and/or driving slug 702 can be selectively designed. For example, a length of the mandrel 700 may be changed according to a final shape of the prismatic cell battery 100.

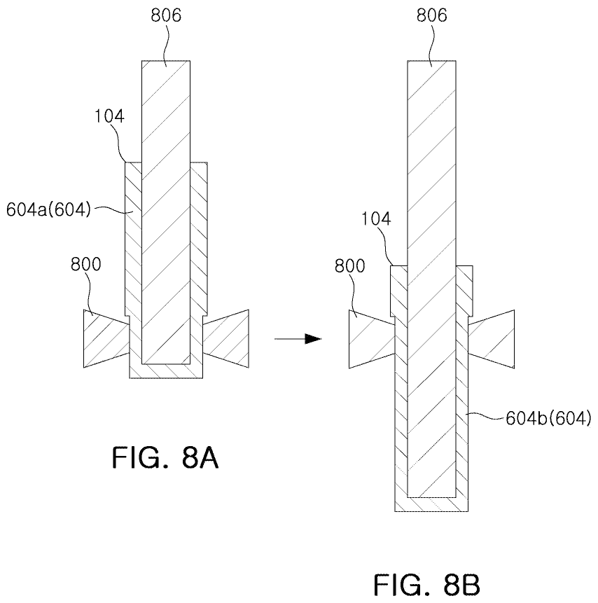

FIGS. 8A and 8B are a diagram for illustrating an ironing process.

In an embodiment, the can 104 may be further formed through ironing after the impact extrusion process. For example, an ironing process may be further performed on the second workpiece 604 manufactured by the impact extrusion process of FIG. 7.

The ironing process may refer to a process of pressing a first workpiece (e.g., the first workpiece 602 of FIG. 7B) using an iron 800, to deform the shape of the first workpiece 602. For example, a thickness of at least a portion of the second workpieces 604a and 604b may be different from a thickness of the first workpiece 602.

The iron 800 may press the can 104 to draw a material in a given direction, so that a thinner, larger, and more uniform can 104 may be produced. In an embodiment, an internal mold 806 may be disposed inside the can 104, and the iron 800 may apply pressure to the can 104 outside the can 104. An un-ironed portion of the prismatic cell can 104 is illustrated in the second workpiece 604b. Referring to FIG. 8A and FIG. 8B, the iron 800 may move from a lower portion of the can 104 to an upper portion thereof. The iron 800 may deform a shape of the can 104 by lifting a material of the second workpieces 604a and 604b. For example, the iron 800 may produce an ironed portion of the prismatic cell can 104 illustrated in the second workpiece 604b. A thickness and/or shape of at least a portion of the can 104 may be deformed in an ironing process.

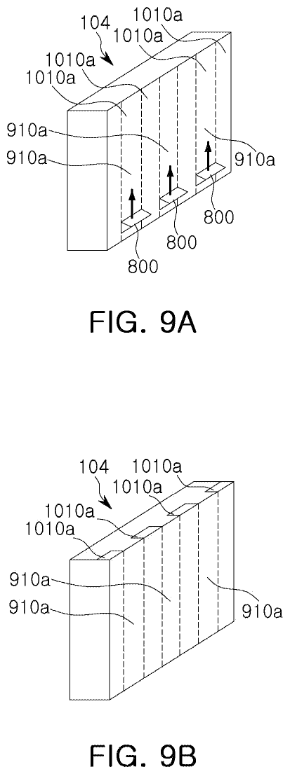

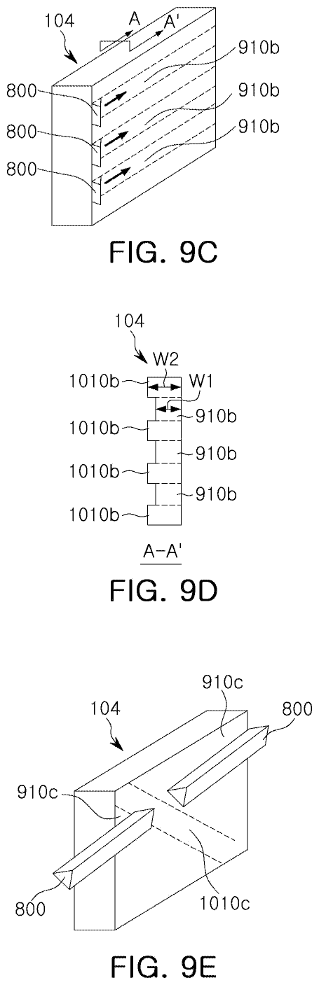

FIGS. 9A to 9E are views for illustrating a can to which an ironing process is applied, according to various embodiments. Strength and/or rigidity of the can 104 of the battery cell 100 may be improved using an ironing (e.g., wall ironing) process. The can 104 of FIGS. 9A to 9E may be manufactured using the ironing process of FIG. 8A and FIG. 8B. The can 104 may be applied to the battery cell 100 of FIG. 1.

Referring to FIGS. 9A to 9E, the can 104 may include at least one of ironing regions 910a, 910b, and 910c and reinforcing regions 1010a, 1010b, and 1010c. Thicknesses of the ironing regions 910a, 910b, and 910c may be different from thicknesses of the reinforcing regions 1010a, 1010b, and 1010c. For example, a second thickness w2 of the second reinforcing region 1010b may be greater than a first thickness w1 of the second ironing region 910b.

Referring to FIGS. 9A and 9B, the can 104 may include a first ironing region 910a formed using three irons 800 equally spaced in a vertical side surface of the can 104. For example, the can 104 may include at least one ironing region 910a in a vertical direction.

For example, when an iron 800 moves upwardly and downwardly or from a lower portion to an upper portion, the iron 800 may form an ironing region 910a on a surface of the can 104. The other portion of the can 104 in which the ironing region 910a is not formed may be referred to as a reinforcing region 1010a. According to an embodiment (e.g., FIG. 9B), the can 104 may include four reinforcing regions 1010a and three vertical ironing region 910a having a thinner thickness than the reinforcing regions 1010a. In an embodiment, a thickness of the vertical ironing region 910a may be substantially the same as a normal thickness of a prismatic cell battery can 104 formed by a currently known impact extrusion process. Accordingly, the thickness of the reinforcing region (e.g., the first reinforcing region 1010a) may be greater than that of the can 104 of the prismatic cell battery 100. In an embodiment, the first reinforcing region 1010a may be referred to as a vertical rail or rail portion.

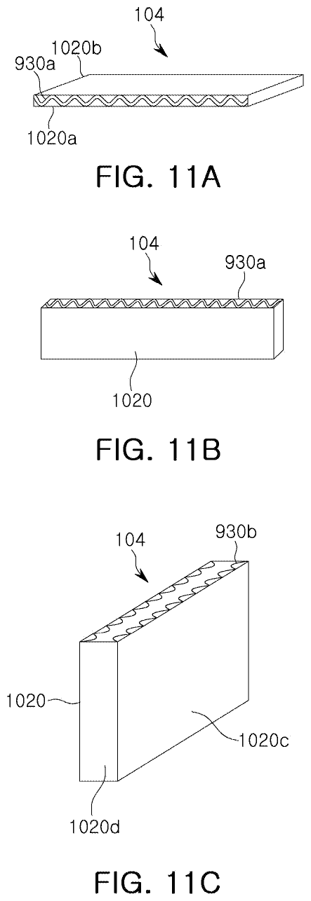

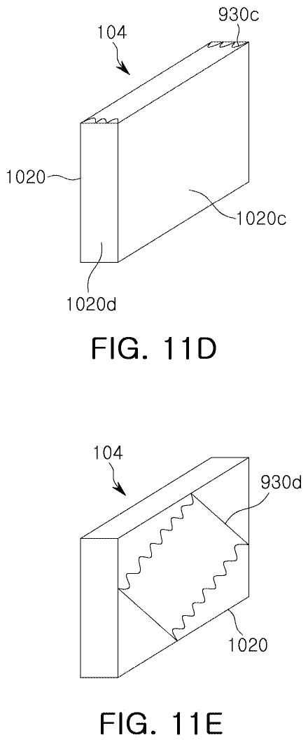

According to an embodiment, the can 104 may include a corner portion disposed between a wide surface (e.g., the wide surface 1020c of FIG. 11C) and a narrow surface (e.g., the narrow surface 1020d of FIG. 11C). The reinforcing regions 1010a, 1010b, and 1010c may be disposed or formed on at least one of the wide surface 1020c, the narrow surface 1020d, and the corner portion.

In an embodiment, by an ironing process, a reinforcing region 1010a located at a corner portion of the can 104 of the prismatic cell battery 100 may be formed. The ironing process may provide a prismatic cell battery can 104 with increased structural strength with a thicker material at the corners of the can 104. Since the thickness of the corner portion of the can 104 is increased due to the ironing process, the structural strength of the can 104 may be improved.

The ironing regions 910a, 910b, and 910c may be formed on inner and/or outer surfaces of the can 104. In an embodiment, the first ironing region 910a may be formed on the outer surface of the can 104. For example, the first ironing region 910a may be formed on the outer surface of the can 104 using an iron 800 and an internal mold (e.g., the internal mold 806 of FIG. 8A). According to an embodiment (not shown), the first ironing region 910a may be formed on the inner surface of the can 104. For example, in the ironing process, an external mold (not shown) surrounding the outer surface of the can 104 and an iron pressing the inner surface of the can 104 may be used.

At least a portion of the description of the first ironing region 910a and the first reinforcing region 1010a may be applied to a second ironing region 910b (e.g., a horizontal ironing region), a third ironing region 910c (e.g., an oblique ironing region), a horizontal support region 1010b, and/or an oblique support region 1010.

Referring to FIGS. 9C and 9D, the can 104 may include a second ironing region 910b formed using three irons 800 equally spaced in a horizontal side surface of the can 104. For example, when the can 104 moves the iron 800 from left to right or from a left side to a right side, three horizontal ironing region 910b that are thinner than the four horizontal support regions 1010b illustrated in FIGS. 9C and 9D may be created.

According to an embodiment (e.g., FIG. 9E), the can 104 may include an oblique ironing region 910c and an oblique support region 1010c. For example, when a pair of irons 800 move in parallel with each other, an oblique support region 1010c passing through a central portion of the can 104 may be formed.

The shape of the can 104 illustrated in FIGS. 9A to 9E is exemplary. For example, in the case of a structure for improving the strength of the can 104, the number and/or shape of the ironing regions 910a, 910b, and 910c and/or the reinforcing regions 1010a, 1010b, and 1010c are not limited.

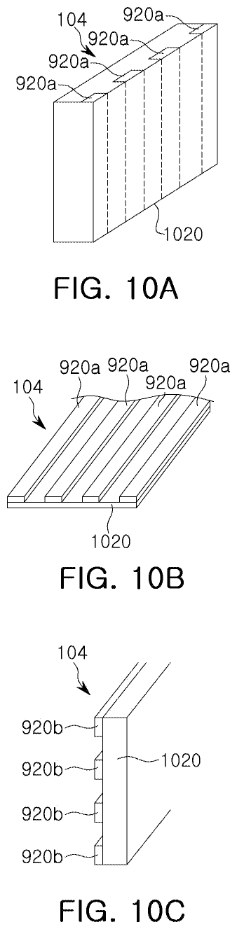

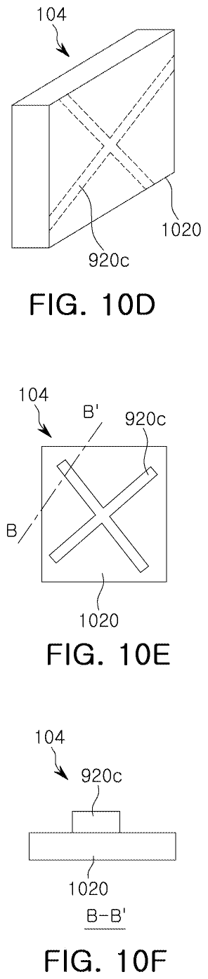

FIGS. 10A to 10F are views for illustrating a can including a support rod according to various embodiments. Strength and/or rigidity of the battery cell 100 may be improved by support rods 920a, 920b, and 920c.

According to an embodiment (e.g., FIGS. 10A and/or 10B), the can 104 may include four first support rods 920a. The first support rod 920a may be referred to as a vertical support rod. The first support rod 920a may be disposed on the support region 1020 of the can 104. Structural strength of the can 104 may be improved by the first support rod 920a. For example, the support region 1020 has the shape of a general can 104, and the thickness of the can 104 is increased by the support rod 920, so that structural strength thereof can be improved. In an embodiment, the support rod 920 may be coupled to the support region 1020 of the can 104 using an adhesive or welding.

According to an embodiment (e.g., FIG. 10B), the can 104 may include a plurality of first support rods 920a welded to the support region 1020. The plurality of first support rods 920a may be arranged substantially in parallel. The support region 1020 may be an aluminum sheet. In an embodiment, the support region 1020 may be referred to as a support plate. In the present document, the description of the first support rod 920a may be applied to the second support rod 920b and the third support rod 920c.

According to an embodiment, the support region 1020 to which the first support rod 920a is attached may be integrally formed with the can 104. According to an embodiment, the support region 1020 to which the first support rod 920a is attached may be formed as a separate component from the can 104. For example, the support region 1020 may be manufactured in a shape of a support plate, and welded or attached to the can 104.

According to an embodiment (e.g., FIG. 10C), the can 104 may include a second support rod 920b. The second support rod 920b may be referred to as a horizontal support rod. For example, the can 104 may include a plurality of second support rods 920b extending parallel to each other in a horizontal direction.

According to an embodiment (not shown), the can 104 may include a first support rod 920a and a second support rod 920b. For example, the can 104 may include a support rod having a checkerboard pattern. The support rod having the checkerboard pattern means a support rod having a shape in which the first support rod 920a and the second support rod 920b are combined or integrated.

According to an embodiment (e.g., FIGS. 10D to 10F), the can 104 may include a third support rod 920c. The third support rod 920c may be referred to as a cross-type support rod. The third support rod 920c may include a plurality (e.g., two rods), substantially vertically arranged. In an embodiment, at least a portion of the third support rod 920c may be disposed on a central portion of the can 104.

According to an embodiment, the third support rod 920c may be coupled to a support region 1020. For example, the third support rod 920c may be connected to the support region 1020 using welding.

In the present document, the support rod 920 is connected to an inner surface of the can 104 and/or the support region 1020, but a position of the support rod 920 is not limited thereto. For example, in an embodiment not shown, the support rod 920 may be connected to an outer surface of the can 104 and/or the support region 1020.

In an embodiment, the support region 1020 and/or support rods 920a, 920b, and 920c may include aluminum. For example, the support rods 920a, 920b, 920c may be formed of the same aluminum as the can 104 and/or support region 1020. In an embodiment, the support rods 920a, 920b, and 920c, the can 104, and/or the support region 1020 may include titanium.

According to an embodiment, the support rods 920a, 920b, 920c may be disposed on an inner and/or outer surface of the can 104.

According to an embodiment, at least a portion of the support rods 920a, 920b, and 920c of FIGS. 10A to 10F may be used with at least a portion of the reinforcing regions (e.g., the reinforcing regions 1010a, 1010b, and 1010c of FIGS. 9A to 9E), previously described.

FIGS. 11A to 11E are views for illustrating a can including a reinforcing cover according to various embodiments.

Referring to FIGS. 11A to 11E, the can 104 may include a support region 1020 and a reinforcing cover 1030. The description of the can 104 and/or the support region 1020 of FIG. 10A may be applied to the can 104 and/or the support region 1020 of FIGS. 11A to 11E.

The reinforcing covers 930a, 930b, 930c, and 930d may include a plurality of protrusions and a plurality of grooves. For example, the reinforcing covers 930a, 930b, 930c, and 930d may have a corrugated shape. According to an embodiment, the reinforcing covers 930a, 930b, 930c, and 930d may be referred to as corrugated reinforcements. According to an embodiment, the reinforcing covers 930a, 930b, 930c, and 930d may be manufactured using an extrusion process (e.g., the impact extrusion process of FIGS. 7A and 7B).

Positions in which the reinforcing covers 930a, 930b, 930c, and 930d are formed on the can 104 may be selectively designed. According to an embodiment (e.g., FIG. 11A), the can 104 may include a transversely arranged first reinforcing cover 930a. In an embodiment, the first reinforcing cover 930a may be formed on inner surfaces of plates 1020a and 1020b of the can 104. The plates 1020a and 1020b of the can 104 may include aluminum. The reinforcing cover 930 may be formed by being extruded from the plates 1020a and 1020b. In an embodiment, the plates 1020a and 1020b may be at least a portion of support region 1020 of the can 104. For example, the plates 1020a and 1020b may be a portion of the can 104 forming a wide surface 1020c of the can 104. In an embodiment, the plates 1020a and 1020b may be separate parts that are attached to the support region 1020 of the can 104. The first reinforcing cover 1020a and the second reinforcing cover 1020b may be disposed between the plates 1020a and 1020b connected to the can 104, respectively.

According to an embodiment, the reinforcing cover 930 may include aluminum.The reinforcing cover 930 may be made of the same aluminum as the can 104 or the plates 1020a and 1020b. According to an embodiment, the reinforcing cover 930 may be made of another material, such as titanium, to increase the strength or reduce the weight of the can 104.

The shape of the can 104 and/or the shape of the first reinforcing cover 930a may be selectively designed. For example, according to an embodiment (e.g., FIG. 9A), the first reinforcing cover 930a may extend horizontally. According to an embodiment (e.g., FIG. 9B), the first reinforcing cover 930a may extend vertically.

At least a portion of the description of the first reinforcing cover 930a may be applied to the second reinforcing cover 930b, the third reinforcing cover 930c, and/or the fourth reinforcing cover 940d.

According to an embodiment (e.g., FIG. 11C), the can 104 may include a second reinforcing cover 930b disposed on a wide surface 1020c. The wide surface 1020c may be referred to as a relatively long side surface of the can 104. The second reinforcing cover 930b may cover at least a portion of the wide surface 1020c of the can 104. The second reinforcing cover 930b may prevent the wide surface 1020c of the can 104 from being bent or damaged. According to an embodiment, the second reinforcing cover 930b may be formed in a vertical direction.

According to an embodiment (e.g., FIG. 11D), the can 104 may include a third reinforcing cover 930c disposed on a narrow surface 1020d. The narrow surface 1020d may be referred to as a relatively short side surface of the can 104. The third reinforcing cover 930c may cover at least a portion of the narrow surface 1020d of the can 104. The third reinforcing cover 930c may prevent the narrow surface 1020d of the can 104 from being bent or damaged. According to an embodiment, the third reinforcing cover 930c may be formed in a vertical direction.

According to an embodiment (not shown), the can 104 may include a reinforcing cover covering a wide surface 1020c and a narrow surface 1020d.

According to anembodiment (not shown), the can 104 may include a reinforcing cover located on a bottom plate of the can 104.

According to an embodiment (e.g., FIG. 11E), the can 104 may include a fourth reinforcing cover 930d disposed on a wide surface 1020c of the can 104. The fourth reinforcing cover 930d may include a corrugated reinforcement extending obliquely with respect to an extending direction of the wide surface 1020c of the can 104. The fourth reinforcing cover 930d may contact not only a side surface of the can 104, but also an upper portion and a lower portion thereof. Due to the oblique arrangement of the fourth reinforcing cover 930d, stability of the can 104 may be improved.

According to an embodiment, the reinforcing covers 930a, 930b, and 930c may be disposed on an inner and/or outer surface of the can 104.

According to an embodiment, at least a portion of the reinforcing covers 930a, 930b, and 930c of FIGS. 11A to 11F may be used with at least a portion of the reinforcing regions (e.g., the reinforcing regions 1010a, 1010b, and 1010c of FIGS. 9A to 9E and/or the support rods 920a, 920b, and 920c of FIGS. 10A to 10F), which are previously described.

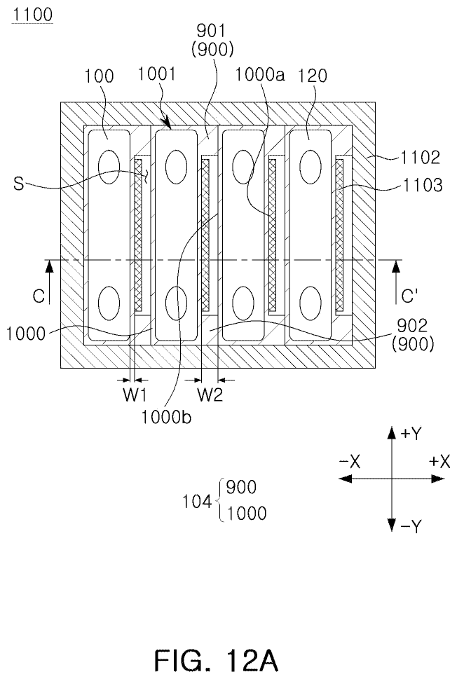

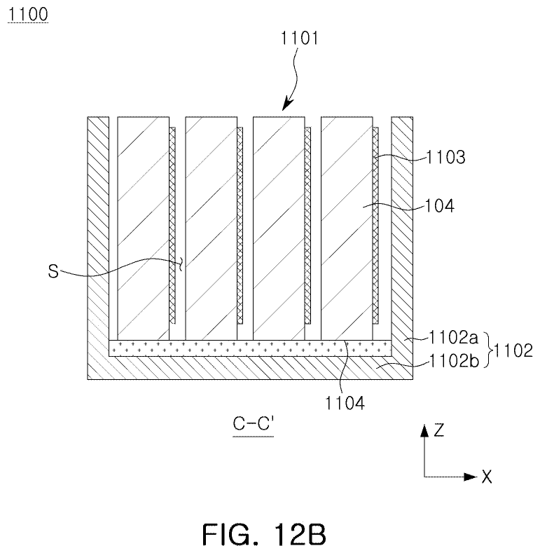

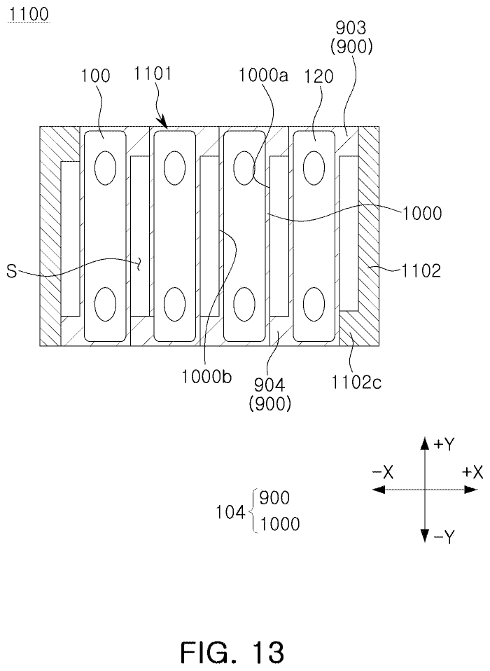

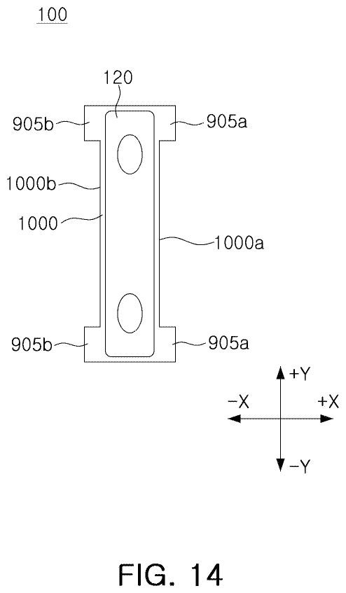

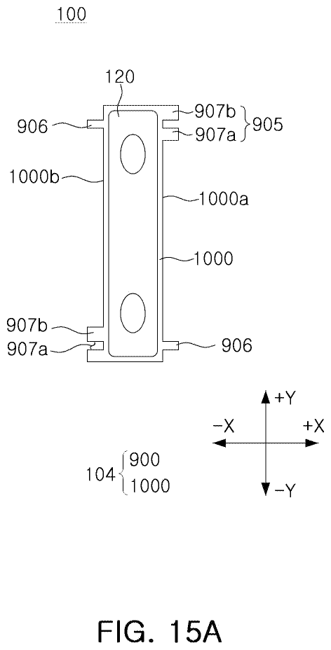

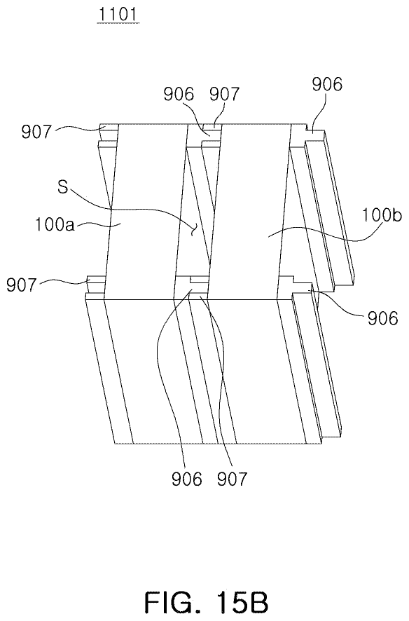

FIG. 12A is a top view of a battery device, according to an embodiment. FIG. 12B is a cross-sectional view along line C-C′ of FIG. 12A. FIG. 13 is a top view of a battery device according to an embodiment. FIG. 14 is a top view of a battery cell, according to an embodiment. FIG. 15A is a top view of a battery cell, according to an embodiment. FIG. 15B is a perspective view of a cell assembly, according to an embodiment.

Referring to FIGS. 12A, 12B and/or 13, a battery device 1100 may include a cell assembly 1101 and a housing 1102. The battery device 1100 may be referred to as a battery module, a battery pack, or a power storage device.

The cell assembly 1101 may include a plurality of battery cells (e.g., the battery cells 100 of FIG. 1). In an embodiment, the cell assembly 1101 may be referred to as a cell stack.

Thehousing 1102 may accommodate the cell assembly 1101. For example, the housing 1102 may provide an accommodation space for accommodating the cell assembly 1101. In an embodiment, housing 1102 may be referred to as a module case or pack case.

According to an embodiment, the housing 1102 may include a bottom member 1102b supporting a bottom surface of the cell assembly 1101 and a sidewall member 1102a extending from the bottom member 1102b. The shape of the housing 1102 may be selectively changed according to the design of the battery device 1100.

According to an embodiment,the battery device 1100 may include a bus bar (not shown) connected to a battery cell 100.

The battery cell 100 may include an electrode assembly (e.g., jelly roll 106 of FIG. 1), a cap assembly (e.g., cap assembly 120 of FIG. 2A), and a can 104 accommodating the electrode assembly.

Descriptions of the can 104 of FIGS. 9A to 9E, the can 104 of FIGS. 10A to 10F, and/or the can 104 of FIGS. 11A to 11E may be applied to the can 104 of FIGS. 12A to 15.

For example, the reinforcing region 900 of the can 104, the support region 1000 of the can 104 may refer to a portion of the can 104 having the thickness or shape of a conventional can 104.

The support region 1000 may be ironing regions 910a, 910b, 910c of FIGS. 9A to 9E, the support region 1020 of FIGS. 10A to 10F, and/or the support region 1020 of FIGS. 11A to 11E.

The reinforcing region 900 may be reinforcing regions 1010a, 1010b and 1010c of FIGS. 9A to 9E, support rods 920a, 920b and 920c of FIGS. 10A to 10F, and/or reinforcing covers 930a, 930b, and 930c of FIGS. 11A to 11E.

The can 104 may have a different thickness for each part. For example, the can 104 may include a reinforcing region 900 and a support region 1000. The reinforcing region 900 may be disposed on the support region 1000. The reinforcing region 900 disposed on the support region 1000 may refer to a shape extended from the support region 1000 and/or a structure coupled to the support region 1000 using bonding, or the like.

The support region 1000 may have a first thickness W1. The reinforcing region 900 may have a second thickness W2, different from the first thickness W1. The second thickness W2 may be greater than the first thickness W1. According to an embodiment, a thickness of the support region 1000 may be substantially the same as that of a conventional can 104 accommodating the electrode assembly. The reinforcing region 900 is thicker than the conventional can 104, so that strength and durability of the can 104 can be improved.

According to an embodiment, the battery device 1100 may include a heat dissipation space S. The heat dissipation space S may be an empty space located between the support regions 1000 of the plurality of battery cells 100. For example, the reinforcing region 900 may protrude from the support region 1000. An empty space may be formed between the plurality of support regions 1000 due to the protrusion of the reinforcing region 1000. The heat dissipation space S may provide a path through which a fluid (e.g., air) flows. In an embodiment, the heat dissipation space S may be referred to as a heat dissipation channel.

According to an embodiment, the battery device 1100 may include a heat dissipation member 1103. The heat dissipation member 1103 may be attached to the can 104. For example, the heat dissipation member 1103 may be disposed on the support region 1000 of the can 104. In an embodiment, the heat dissipation member 1103 may be located in the heat dissipation space S. In an embodiment, the heat dissipation member 1103 may include a thermal interface material (TIM).

According to an embodiment, the battery device 1100 may include a thermal adhesive 1104 for connecting a cell assembly 1101 to a housing 1102. The thermal adhesive 1104 may be positioned between the cell assembly 1101 and the housing 1102. For example, a thermal adhesive 1104 may be disposed between a lower surface of the can 104 and a bottom member 1102b of the housing 1102.

A shape of the can 104 may be designed in various ways. For example, if the reinforcing region 900 may form a heat dissipation space S or improve the strength of the can 104, the structure of the can 104 can be changed.

According to an embodiment (e.g., FIGS. 12A and 12B), the reinforcing region 900 may include a first protrusion 901 and a second protrusion 902 extending in the same direction from an external surface of the support region 1000. For example, the first protrusion 901 may protrude from one end or an edge of one surface 1000a of the support region 1000 in a first direction (+X direction). The second protrusion 902 may protrude from the other end or edge of one surface 1000a of the support region 1000 in the first direction.

According to an embodiment (e.g., FIG. 13), the reinforcing region 900 may include a third protrusion 903 and a fourth protrusion 904 extending in different directions from an external surface of the support region 1000.For example, the support region 1000 may include a first outer surface 1000a in a first direction (+X direction) and a second outer surface 1000b in a second direction (−X direction), opposite to the first direction (+X direction). The third protrusion 903 may protrude from a first end (e.g., an end thereof in a +Y direction) of the first outer surface 1000a in the first direction (+X direction). The fourth protrusion 904 may protrude from a second end (e.g., an end thereof in a −Y direction) of the second outer surface 1000b in the second direction (−Y direction). According to an embodiment, the housing 1102 may have a shape corresponding to the reinforcing region 900. For example, the housing 1102 may include a protrusion 1102c protruding in a size corresponding to the protrusions 903 and 904.

According to an embodiment (e.g., FIG. 14), the reinforcing region 900 may include a plurality of protrusions 905a and 905b protruding from both directions of the support region 1000. For example, the support region 1000 may include a first outer surface 1000a in a first direction (+X direction) and a second outer surface 1000b in a second direction (−X direction), opposite to the first direction (+X direction). The reinforcing region 900 may include a fifth protrusion 905a protruding from both ends of the first outer surface 1000a in the first direction (+X direction) and a sixth protrusion 905b protruding from both ends of the second outer surface 1000b in the second direction (−X direction).

According to an embodiment (e.g., FIGS. 15A and 15B), the reinforcing region 900 may include a plurality of protrusions 906 and 907 protruding from both directions of a support region 1000. For example, the support region 1000 may include a first outer surface 1000a in a first direction (+X direction) and a second outer surface 1000b in a second direction (−Xdirection).

The reinforcing region 900 may include a seventh protrusion 906 and an eighth protrusion 907 which may be connected to each other. The eighth protrusion 908 may include a groove 907a for accommodating the seventh protrusion 906 and a protruding member 907b forming the groove 907a. The seventh protrusion 906 may be inserted into the groove 907a.

According to an embodiment (e.g., FIG. 15A), the reinforcing region 900 may include a seventh protrusion 906 protruding from a second end (an end facing −Ydirection) of the first outer surface 1000a and a first end (an end facing +Y direction) of the second outer surface 1000b and an eighth protrusion 907 protruding from a first end (an end facing +Y direction)of the first outer surface 1000a and a second end (an end facing −Y direction) of the second outer surface 1000b.

According to an embodiment (e.g., FIG. 15B), the reinforcing region 900 may include a seventh protrusion 906 protruding in a first direction (+X direction) from both ends of the first outer surface 1000a and an eighth protrusion 907 protruding in a second direction (−X direction) from both ends of the second outer surface 1000b.

As set forth above, according to the present disclosure, the battery cell includes a case including a reinforcing region. Durability of the battery cell may be increased by the reinforcing region.

A heat dissipation space may be formed by the reinforcing region. Due to the heat dissipation space, heat dissipation performance of the battery cell may be improved.

The functions performed in the processes and methods may be implemented in a different order. Furthermore, the outlined steps and operations are only provided as examples, and some of the steps and operations may be optional, combined into fewer steps and operations, or expanded into additional steps and operations without detracting from the essence of the disclosed embodiments.

What is claimed is:

1. A battery cell, comprising:
anelectrode assembly; and
a case accommodating the electrode assembly,
wherein the case includes a support region surrounding at least a portion of the electrode assembly and a reinforcing region disposed on the support region.

2. The battery cell of claim 1, wherein the support region comprises an ironing region formed using an ironing process, and
a first thickness of theironing region is less than a second thickness of the reinforcing region.

3. The battery cell of claim 1, wherein the reinforcing region comprises at least one support rod connected on the support region.

4. The battery cell of claim 1, wherein the reinforcing region is connected to the support region, and comprises a reinforcing cover having a plurality of protrusions and a plurality of grooves.

5. The battery cell of claim 1, wherein the case comprises a wide surface, a narrow surface, and a corner portionlocatedbetween the wide surface and the narrow surface, and
the reinforcing region is disposed on at least one of the wide surface, the narrow surface, and the corner portion.

6. A battery device, comprising:
a cell assembly including a plurality of battery cells; and
a housing accommodating the cell assembly,
wherein each of the plurality of battery cells includes
an electrode assembly, and a case accommodating the electrode assembly,
wherein the case includes a support region surrounding at least a portion of the electrode assembly and a reinforcing region disposed on the support region,
wherein the cell assembly includes a heat dissipation space located between a support region of each of the plurality of battery cells.

7. The battery device of claim 6, wherein the support region comprises an ironing region formed using an ironing process,
wherein a first thickness of the ironing region is than a second thickness of the reinforcing region.

8. The battery device of claim 6, wherein the reinforcing region comprises at least one support rod connected to the support region.

9. The battery device of claim 6, wherein the reinforcing region is connected to the support region, and comprises a reinforcing cover having a plurality of protrusions and a plurality of grooves.

10. The battery device of claim 6, further comprising:
a heat dissipation member attached to the support region, and located within the heat dissipation space.

11. The battery device of claim 6, further comprising:
a thermal adhesive connecting the cell assembly and the housing.

12. The battery device of claim 6, wherein the reinforcing region comprises a first protrusion extending froman outer surface of the support region in a first direction, and a second protrusion extending in the first direction.

13. The battery device of claim 6, wherein the reinforcing region comprises a third protrusion extending from a first end of a first outer surface of the support region in a first direction, and a fourth protrusion extending from a second outer surface of the support region in a second direction, opposite to the first direction,
the third protrusion is located at a first end of the case, and
the fourth protrusion is located at a second end of the case, opposite to the first end.

14. The battery device of claim 6, wherein the reinforcing region comprises a plurality of fifth protrusions extending from a first outer surface of the support region in a first direction; and
a plurality of sixth protrusions extending from a second outer surface of the support region in a second direction, opposite to the first direction.

15. The battery device of claim 14, wherein the reinforcing region comprises a seventh protrusion including an insertion portion, and
an eighth protrusion in which a groove for accommodating the insertion portion is formed.
